(19) United States
(12) Patent Application Publication
(10) Pub. No.: US 2026/0134556 A1
(43) Pub. Date: May 14, 2026

(54) SELF-SUPERVISED FEATURE DISENTANGLEMENT FOR CALIBRATION-FREE MULTI-CAMERA MULTI-OBJECT TRACKING

(71) Applicant: NEC Laboratories America, Inc., Princeton, NJ (US)

(72) Inventors: Deep Patel, Mount Holly, NJ (US); Iain Melvin, Princeton, NJ (US); Renqiang Min, Princeton, NJ (US); Ruiqi Xian, Chapel Hill, NC (US)

(21) Appl. No.: 19/382,851

(22) Filed: Nov. 7, 2025

Related U.S. Application Data
(60) Provisional application No. 63/720,152, filed on Nov. 13, 2024.

(51) Int. Cl. G06T 7/292; G06T 7/246

(52) U.S. Cl. CPC G06T 7/292; G06T 7/246; G06T 2207/20021

(57) ABSTRACT

Systems and methods for self-supervised feature disentanglement for calibration-free multi-camera multi-object tracking. View-specific features and view-agnostic features of a tracked entity can be identified from different camera views by encoding masked detection features of the tracked entity. The masked detection features can be reconstructed into single-view feature representations from the view-specific features. Cross-view feature representations can be generated from the view-agnostic features that capture shared characteristics from the different camera views. The single-view feature representations and the cross-view feature representations can be combined into multi-entity multi-camera tracks that capture the characteristics of the tracked entity from the different camera views for downstream tasks.

### RELATED APPLICATION INFORMATION

This application claims priority to U.S. Provisional App. No. 63/720,152, filed on Nov. 13, 2024, incorporated herein by reference in its entirety.

### BACKGROUND

### Technical Field

The present invention relates to multi-object tracking with artificial intelligence (AI), and more particularly to self-supervised feature disentanglement for calibration-free multi-camera multi-object tracking.

### Description of the Related Art

AI models have been progressing in a rapid state due to their popularity. AI models have been used for image processing and video processing. However, processing images and videos require camera calibration and manual labeling of the entities in the videos to generate accurate predictions.

### SUMMARY

According to an aspect of the present invention, a method is provided including, identifying view-specific features and view-agnostic features of a tracked entity from different camera views by encoding masked detection features of the tracked entity, reconstructing the masked detection features into single-view feature representations from the view-specific features, generating cross-view feature representations from the view-agnostic features that capture shared characteristics from the different camera views, and combining the single-view feature representations and the cross-view feature representations into multi-entity multi-camera tracks that capture the characteristics of the tracked entity from the different camera views for downstream tasks.

According to another aspect of the present invention, a system is provided including a memory device, one or more processor devices operatively coupled with the memory device to perform operations including, identifying view-specific features and view-agnostic features of a tracked entity from different camera views by encoding masked detection features of the tracked entity, reconstructing the masked detection features into single-view feature representations from the view-specific features, generating cross-view feature representations from the view-agnostic features that capture shared characteristics from the different camera views, and combining the single-view feature representations and the cross-view feature representations into multi-entity multi-camera tracks that capture the characteristics of the tracked entity from the different camera views for downstream tasks.

According to yet another aspect of the present invention, a non-transitory computer program product is provided including a computer-readable storage medium including a program code, wherein the program code when executed on a computer causes the computer to perform operations including, identifying view-specific features and view-agnostic features of a tracked entity from different camera views by encoding masked detection features of the tracked entity, reconstructing the masked detection features into single-view feature representations from the view-specific features, generating cross-view feature representations from the view-agnostic features that capture shared characteristics from the different camera views, and combining the single-view feature representations and the cross-view feature representations into multi-entity multi-camera tracks that capture the characteristics of the tracked entity from the different camera views for downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for self-supervised feature disentanglement for calibration-free multi-camera multi-object tracking, in accordance with an embodiment of the present invention;

FIG. 2 is a block diagram that shows a computer system for self-supervised feature disentanglement for calibration-free multi-camera multi-object tracking, in accordance with an embodiment of the present invention; and

FIG. 3 is a block diagram that shows software and hardware components of a computing system for self-supervised feature disentanglement for calibration-free multi-camera multi-object tracking, in accordance with an embodiment of the present invention;

FIG. 4 is a block diagram that shows a neural network for self-supervised feature disentanglement for calibration-free multi-camera multi-object tracking, in accordance with an embodiment of the present invention;

FIG. 5 is a flow diagram that shows a high-level overview of a method of self-supervised feature disentanglement for calibration-free multi-camera multi-object tracking, in accordance with an embodiment of the present invention; and

FIG. 6 is a block diagram that shows a practical application of self-supervised feature disentanglement for calibration-free multi-camera multi-object tracking, in accordance with an embodiment of the present invention . . .

### DETAILED DESCRIPTION OF PREFERRED EMBODIMENTS

In accordance with embodiments of the present invention, systems and methods are provided for self-supervised feature disentanglement for calibration-free multi-camera multi-object tracking.

In the present embodiments, view-specific features and view-agnostic features of a tracked entity can be identified from different camera views by encoding masked detection features of the tracked entity. The masked detection features can be reconstructed into single-view feature representations from the view-specific features. Cross-view feature representations can be generated from the view-agnostic features that capture shared characteristics from the different camera views. The single-view feature representations and the cross-view feature representations can be combined into multi-entity multi-camera tracks that capture the characteristics of the tracked entity from the different camera views for downstream tasks.

Multiple Object Tracking (MOT) is a prevalent issue in computer vision, aiming to identify and track multiple objects within video streams. While single-camera tracking has been extensively studied, the importance of Multi-Camera Multi-Object Tracking (MCMOT) continues to grow with the rising applications of multi-camera systems in surveillance, smart cities, and autonomous vehicles. MCMOT aims to maintain consistent object identities across multiple camera views, addressing inherent challenges such as viewpoint variation, occlusions, and synchronization issues. By integrating diverse viewpoints, MCMOT can provide improved tracking robustness, enhanced scene understanding, and fewer blind spots compared to single-camera methods.

Despite these advantages, achieving effective MCMOT remains challenging. A primary difficulty arises from significant variations in object appearance and motion across different camera views, making reliable object re-identification (ReID) nontrivial. Moreover, many MCMOT methods rely on calibrated camera setups or large-scale annotations. Even minor camera shifts—such as relocating a camera or changing its angle—can break calibration, causing immediate performance declines until the system is recalibrated and annotated data are recollected. Similarly, transitioning to a new scene often necessitates gathering a fresh dataset, performing calibration, and retraining the model. As camera networks expand or reconfigure, the associated computational overhead grows, making frequent recalibration and reannotation both costly and impractical in real-world applications.

To address these limitations, the present embodiments utilize a self-supervised learning framework specifically designed for multi-camera setups with overlapping fields of view. The present embodiments avoid explicit calibration and reduce the need for annotations by leveraging data-driven representation learning. In particular, the present embodiments employ a disentangled feature learning strategy that separates view-agnostic and view-specific features through single-view distillation and cross-view reconstruction.

The present embodiments mitigate viewpoint-based discrepancies and improves cross-view tracking without costly manual calibration or any labeling. The present embodiments can process containing both indoor and outdoor scenes with sparser camera coverage and reduced overlapping fields of view.

Unlike traditional methods that reconstruct from partial observations within the same image and view, the present embodiments utilize a cross-view reconstruction task, enabling reconstruction from observations across different views using view-agnostic features. Furthermore, it incorporates a distillation process from large models to refine the learning of view-specific features.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

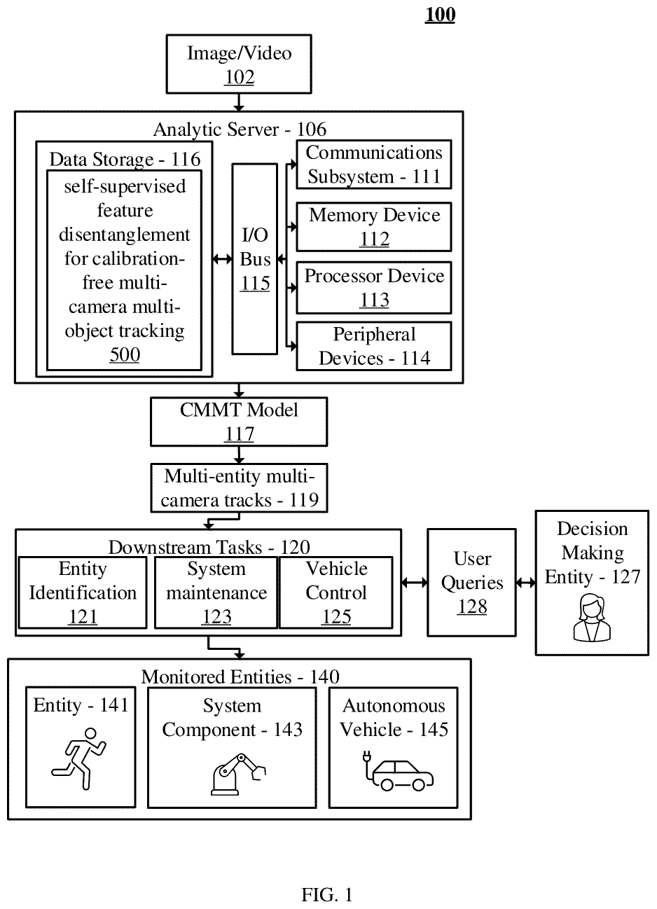

Referring now in detail to the figures in which like numerals represent the same or similar elements and initially to FIG. 1, a block diagram that shows a system for self-supervised feature disentanglement for calibration-free multi-camera multi-object tracking, in accordance with an embodiment of the present invention.

In an embodiment using a system 100, monitored entities 140 can include entity 141, system component 143, and autonomous vehicle 145. The monitored entities 140 can generate an image/video 102. The image/video 102 can be transmitted to an analytic server 106 that can implement self-supervised feature disentanglement for calibration-free multi-camera multi-object tracking 500. The analytic server 106 can obtain a calibration-free multi-camera multi-object tracking (CMMT) model 117 that can generate multi-entity multi-camera tracks 119 which can be utilized to perform downstream tasks 120.

System 100 can be utilized to perform downstream tasks 120 based on the image/video 102 and user queries 128 from a decision-making entity 127. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the image/video 102 (e.g., location images, scene images, entity images such as parts of the entity, etc.) related to the entity 141 can be processed by the analysis server 106 to answer user queries 128 based on the multi-entity multi-camera tracks 119 generated by the analysis server 106. The user queries 128 can be relevant to the entity 141 such as their attributes (e.g., position, direction of movement, color of clothing, etc.), relationship with other entities within a scene (e.g., proximity, behavior, etc.), relationship with the environment, etc. The CMMT model 117 can predict future attributes, and relationships of the entity 141.

Based on the predictions of the CMMT model 117, a corrective action can be generated by the CMMT model 117. The corrective action can include notifying the decision making entity 127 of the predictions about the entity 141 based on their image/video 102, generating resolutions to an issue caused by the entity (e.g., the entity 141 as a disabled vehicle in a traffic scene and the resolution is the deployment of a repair technician, etc.) of the image/video 102 to help with the decision making process of the decision making entity 127, etc.

In system maintenance 123, image/video 102 (e.g., system logs, test cases, hardware status images, etc.) related to the system component 143 can be processed to answer user queries 128 based on based on the multi-entity multi-camera tracks 119 of the system component 143 generated by the analysis server 106. The user queries 128 can be relevant on how to properly maintain the system component 143, or whether the system component is properly functioning based on the input image/video 102. A corrective action can be generated by the analytic server 106 which can include the answer to the user queries 128 (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, redirecting processing of component, etc.) the network system can be autonomously maintained.

In vehicle control 125, image/video 102 (e.g., vehicle part status, traffic scene image, etc.) related to the autonomous vehicle 145 can be processed to answer user queries 128. The user queries 128 can be relevant to how to control the autonomous vehicle 145 given its environment based on the image/video 102. A corrective action can be generated by the analytic server 106 which can include the answer to the user queries 128 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle 145. In an embodiment, the autonomous vehicle 145 can be controlled in response to avoid a predicted event based on a generated trajectory based on the multi-entity multi-camera tracks 119 generated by the analysis server 106 such as multi-vehicle collision, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate test data that can be used to fine-tune/train the CMMT model 117.

Other downstream tasks and practical applications are contemplated.

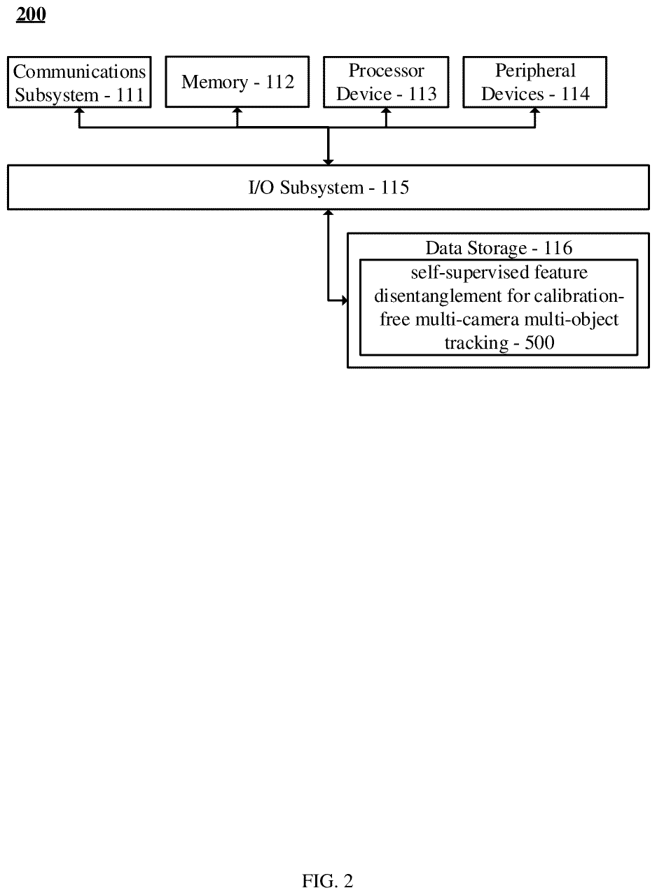

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram that shows a computer system for self-supervised feature disentanglement for calibration-free multi-camera multi-object tracking, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single integrated circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for self-supervised feature disentanglement for calibration-free multi-camera multi-object tracking 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

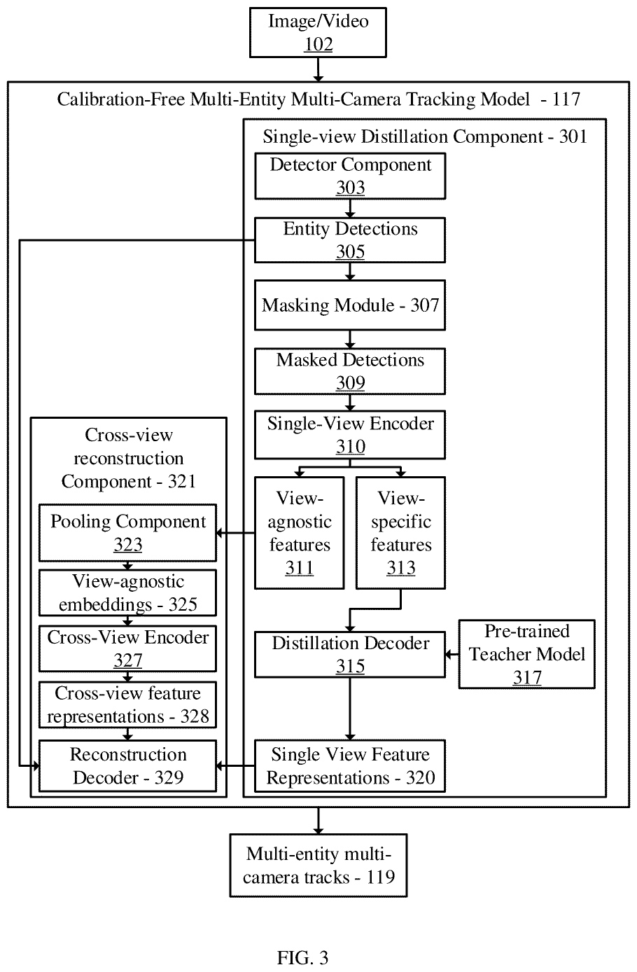

Referring now to FIG. 3, a block diagram that shows software and hardware components of a computing system for self-supervised feature disentanglement for calibration-free multi-camera multi-object tracking, in accordance with an embodiment of the present invention.

In an embodiment, the CMMT model 117 can process image/video 102 and generate multi-entity multi-camera tracks 119 for downstream tasks 120.

The CMMT model 117 can include a single-view distillation component 301 and a cross-view reconstruction component 321.

The single-view distillation component 301 can include a detector component 303 that can process image/video 102 and identify entity detections 305. The single-view distillation component 301 can include a masking module 307 to process entity detections 305 and obtain masked detections 309. The single-view distillation component 301 can include a single-view encoder 310 to process the masked detections 309 and obtain view-agnostic features 311 and view specific features 313. The single-view distillation component 301 can include a distillation encoder 315 which can be guided by a pre-trained teacher model 317 to obtain single view feature representations 320.

The cross-view reconstruction component 321 can include a pooling component which pools view-agnostic features to obtain view-agnostic embeddings 325. The pooled view-agnostic features can be processed by a cross-view encoder 327 to encode shared characteristics from the view-agnostic features and generate cross-view features 328. The entity detections 305 can be reconstructed by a reconstruction decoder 329 from the shared characteristics. The reconstruction output can be compared with the cross-view features 328 and can be combined with the single view feature representations 320 to obtain multi-entity multi camera tracks 119.

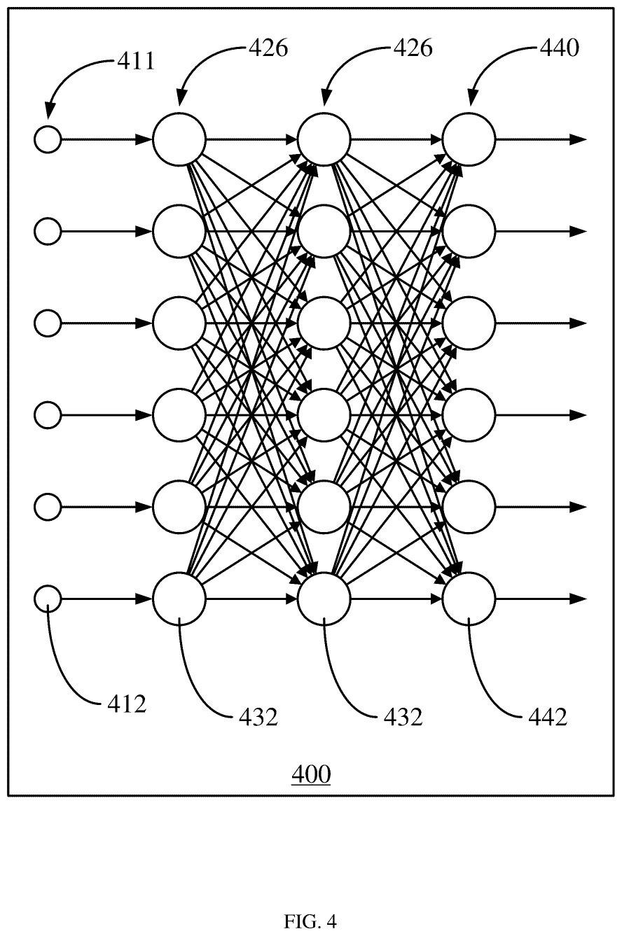

Referring now to FIG. 4, a block diagram that shows a neural network for self-supervised feature disentanglement for calibration-free multi-camera multi-object tracking, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 400, such as a multilayer perceptron, can have an input layer 411 of source neurons 412, one or more computation layer(s) 426 having one or more computation neurons 432, and an output layer 440, where there is a single output neuron 442 for each possible category into which the input example could be classified. An input layer 411 can have a number of source neurons 412 equal to the number of data values 412 in the input data 411. The computation neurons 432 in the computation layer(s) 426 can also be referred to as hidden layers, because they are between the source neurons 412 and output neuron(s) 442 and are not directly observed. Each neuron 432, 442 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons 432 in the one or more computation (hidden) layer(s) 426 perform a nonlinear transformation on the input data 412 that generates a feature space. The classes or categories may be more easily separated in the feature space than in the original data space.

In an embodiment, the CMMT model 117 can be trained to perform self-supervised multi-entity multi-camera detection by updating the model parameters and hidden layers of the CMMT model 117 through iterations of reconstructing entity detections 305 based on input image/video 102.

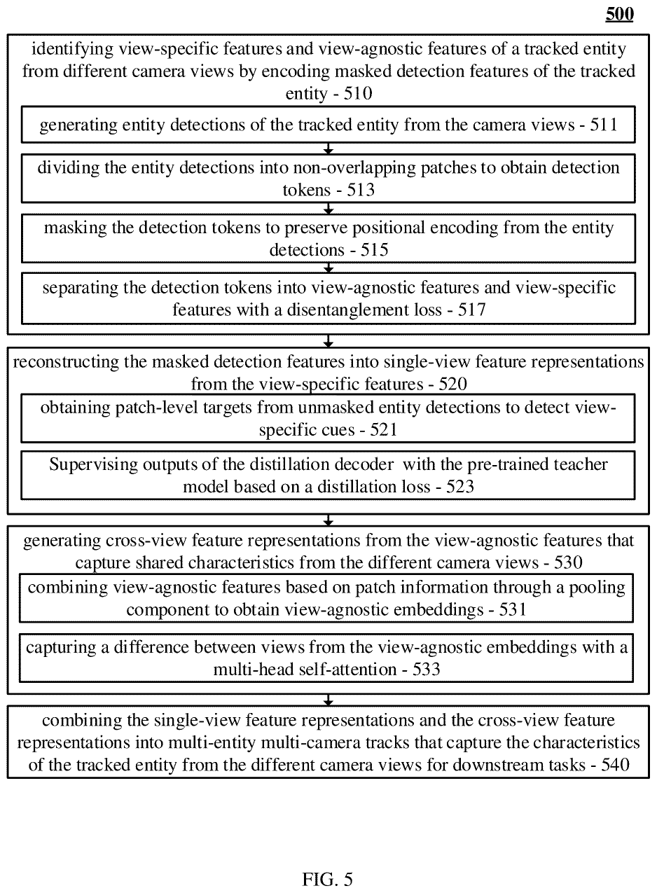

Referring now to FIG. 5, a flow diagram that shows a high-level overview of a method of self-supervised feature disentanglement for calibration-free multi-camera multi-object tracking, in accordance with an embodiment of the present invention.

In the present embodiments, view-specific features and view-agnostic features of a tracked entity can be identified from different camera views by encoding masked detection features of the tracked entity. The masked detection features can be reconstructed into single-view feature representations from the view-specific features. Cross-view feature representations can be generated from the view-agnostic features that capture shared characteristics from the different camera views. The single-view feature representations and the cross-view feature representations can be combined into multi-entity multi-camera tracks that capture the characteristics of the tracked entity from the different camera views for downstream tasks.

Multi-camera multi-object tracking (MCMOT) aims to track all subjects across synchronized video streams from V cameras and associate identities across views. This can be formulated as a spatiotemporal association problem with:

Intra-camera tracking: Given detections

$${D}_{t}^{v} = \{ {D}_{t}^{v} \vert i = 1 , 2 , … , {N}_{t}^{v} \}$$

at frame t in view v, associate them over time to form tracklets τₜ^{v}, as in single-camera MOT.

Cross-view matching: detections

$${\overline{D}}_{t} = \{ {\overline{D}}_{t}^{1} , {\overline{D}}_{t}^{2} , … , {\overline{D}}_{t}^{V} \}$$

can be matched across views at time t that belong to the same subject. Like single-camera methods, MCMOT relies on robust feature representations to ensure reliable association with features and camera viewpoints that remain consistent across time while being discriminative enough to separate different identities.

Given all detections at time t,

$${D}_{t} = \{ {D}_{t}^{1} , {D}_{t}^{2} , … , {D}_{t , {N}_{t}^{V}}^{V} \} ,$$

for each detection

$${D}_{t , i}^{V}$$

at least two types of features can be extracted:

View-agnostic features (fa): Capture identity-preserving cues (e.g., silhouette, body shape, pose) for cross-view matching. View-specific features (fs): Encode appearance-specific details (e.g., clothing, texture) useful for temporal tracking within a view. These features can support both within-view and cross-view association, enabling robust identity continuity across space and time in uncalibrated multi-camera environments.

In block 510, view-specific features and view-agnostic features of a tracked entity can be identified from different camera views by encoding masked detection features of the tracked entity.

In an embodiment, to identify features specific to the different camera views, detection features from entity detections of a tracked entity can be detected.

In block 511, entity detections of the tracked entity can be generated from the camera views.

At each timestep t, a number of V frames are captured from input video 102 from cameras with V count. The entity detections 305 can include bounding boxes of tracked entities. The detector component 303 can process each frame to obtain entity detections 305 for tracked entities. The entity detections 305 can include detected regions from the bounding boxes that can be cropped and resized to a uniform size (H, W). Since the number of detections can vary across views, the maximum number of detections N can be used as a preset.

For views with fewer detections, zero tensors of size (H, W, C) are added to represent missing detections. The resulting input is

$${D}_{t} = \{ {D}_{t , i}^{j} ∈ {ℝ}^{V \times N \times H \times W \times C} \vert i = 1 , 2 , … , N ; j = 1 , 2 , … , V \} ,$$

which consolidates all detections from all views at time t.

In block 513, entity detections can be divided into non-overlapping patches to obtain detection tokens.

Each entity detection 305 is divided into non-overlapping patches,

$$P = {\{ {P}_{i} \vert {P}_{i} ∈ {ℝ}^{C \times h \times w} \}}_{i = 1}^{M} ,$$

where

$$M = \frac{H}{h} \times \frac{W}{w}$$

is the total number of patches. These patches are converted into a sequence of detection tokens,

$$K = {\{ {K}_{i} \vert {K}_{i} ∈ {ℝ}^{E} \}}_{i = 1}^{M} ,$$

using patch embedding and positional encoding, where E is the embedding dimension of the hidden vector for each detection token generated by passing the patches through a neural network.

In block 515, the detection tokens can be masked into masked detections to preserve positional encoding from the entity detections. The masked detections 309 can be obtained from the tokens. A subset of tokens K^{vis}⊂K (e.g., 25%) is randomly sampled without replacement, and the remaining tokens are masked, following a masking strategy such as random masking.

The same mask is applied across all detections Dₜ to ensure consistency between views. This shared mask preserves positional encoding and prevents disruptions in cross-view reconstruction, which relies on consistent masking across views, as discussed later.

The single-view encoder 310 Φₛᵥₑ can be a standard Vision Transformer (ViT) applied to the Mᵥᵢₛ visible, unmasked patch tokens K^{vis}⊂K. Unlike conventional masked autoencoders, the single-view encoder 310 processes all unmasked tokens from entity detections 305 within each view, enabling multi-head self-attention across patches in a single view. This setup captures variations between different detections, with consistent masked token positions enhancing cross-detection learning. Positional embeddings for the patch tokens are generated using a sinusoidal function across all detection patches within a view. This ensures that while unmasked tokens may occupy the same positions across detections because of the consistent mask, their positional embeddings remain distinct.

In block 517, the detection tokens can be separated into view-agnostic features and view-specific features with a disentanglement loss.

The single-view encoder 310 can generate outputs of features split evenly into view-agnostic features 311 fₐ (first half) and view-specific features 313 fₛ (second half) based on a disentanglement loss, as follows:

$${f}_{a} , {f}_{s} = {Φ}_{sve} ( {K}^{vis} ) , {f}_{a} , {f}_{s} ∈ {ℝ}^{{M}^{vis} \times \frac{E}{2}} .$$

The disentanglement loss can utilize a normalized mutual information (NMI) loss measures the independence between view-agnostic features 311 and view-specific features 313, quantifying how much information about one feature set is shared by the other: L_{disentangle}=NMI(fₐ, fₛ). Minimizing L_{disentangle} enhances feature disentanglement by reducing shared information between the two feature sets.

In block 520, the masked detection features can be reconstructed into single-view feature representations from the view-specific features.

The CMMT model 117 can project the view-specific features 313 to the decoder width E_{d} with a linear layer and concatenate learned embeddings for the masked positions to form a length-M token sequence. This sequence is fed to a shallow ViT distillation decoder 315 Φ_{distill}.

Positional embeddings are added to all tokens so that masked tokens retain their spatial coordinates. The distillation decoder 315 outputs single view feature representations 320 which include per-patch features for the entire detection, \hat{f}ₛ∈ [symbol] .

In block 521, patch-level targets can be obtained from unmasked entity detections to detect view-specific cues.

In an embodiment, in parallel, the corresponding unmasked entity detections 305 is processed by a pretrained teacher to obtain patch-level targets. Before computing the distillation loss, a linear head is used to align the student features f_{student} to the teacher feature space f_{teacher}. The student features include the outputs of the distillation decoder 315.

The pre-trained teacher model 317 can utilize transformer frameworks such as publicly released ViT-L MAE™ model pretrained on an image training dataset such as ImageNet-1K (self-supervised). The pre-trained teacher model 317 can obtain single view feature representations that include view-specific cues—e.g., color, fine textures, and local details—while contributing less to view-agnostic properties such as aspect ratio, coarse silhouette, or pose.

In block 523, the outputs of the distillation decoder can be supervised with the pre-trained teacher model based on a distillation loss.

The pre-trained teacher model 317 can supervise the distillation decoder 315 through a distillation loss. The distillation loss can facilitate knowledge transfer from a larger teacher model pretrained on a different dataset. Given potential domain differences, Smooth L1 Loss is used to mitigate the impact of outliers: L_{distillation}=SmoothL1(f_{student}, f_{teacher}). In an embodiment, the distillation decoder 315 and the single-view encoder 310 can be trained by the pre-trained teacher model 317 with Kullback-Liebler (KL) divergence between the output logits of the distillation decoder 315 and the single-view encoder 310.

In block 530, cross-view feature representations can be generated from the view-agnostic features that capture shared characteristics from the different camera views.

In block 531, the view-agnostic features can be combined based on patch information through a pooling component to obtain view-agnostic embeddings.

The view-agnostic features 311 can be passed through a pooling component 323 which can include a pooling layer to combine patch information, producing single view-agnostic embeddings 325 per entity detection 305. Note that no information is mixed across cameras at this stage—only patches within the same detection are combined.

All embeddings from each view can be projected into the cross-view encoder dimension, E_{d}, and sent to the cross-view encoder 327. The cross-view encoder 327 can utilize a transformer framework such as a ViT framework.

In block 533, the difference between views from the view-agnostic embeddings can be captured with a multi-head self-attention.

Multi-head self-attention can be applied across these embeddings to capture differences between views. The output cross-view feature 328 \hat{f}ₐ∈ [symbol] is learnt through all the views, representing the high-level semantic features that are universal across views.

In block 540, the single-view feature representations and the cross-view feature representations can be combined into multi-entity multi-camera tracks that capture the characteristics of the tracked entity from the different camera views for downstream tasks.

The cross-view feature 328 \hat{f}ₐ can be combined with the single-view feature representations 320 \hat{f}ₛ for each patch, creating an enriched representation that captures both cross-view consistency and camera-specific details. These combined features are fed into the reconstruction decoder 329, which can reconstruct the original image by predicting pixel values for each masked patch.

During decoding, each output vector from the reconstruction decoder 329 can represent the pixel values of a specific patch, effectively reconstructing masked areas. The final layer of the reconstruction decoder 329 can include a linear projection to match the total pixel count per patch, preserving each patch's spatial structure. After projection, the output is reshaped to form a coherent, reconstructed image, closely resembling the original input including the entity detections 305 from the image/video 102.

The reconstruction loss can calculate the mean squared error (MSE) between the reconstructed and original images in pixel space, applied only to masked patches:

$${L}_{reconstruction} = MSELoss ( {f}_{reconstructed}^{masked} , {f}_{original}^{masked} ) .$$

In an embodiment, the reconstruction decoder 329 and the cross-view encoder 327 can be trained using the reconstruction loss.

The overall loss function combines these components can be used to train the CMMT model 117: Loss=L_{disentangle}+L_{distillation}+L_{reconstruction}.

The present embodiments perform multi-entity multi-view tracking of entities that is independent from camera calibration and human annotations. While both the single-view encoder 310 and distillation decoder 315, and the cross-view encoder 327 are used during self-supervised training, only the single-view encoder 310 is needed at inference.

During inference, all patches are passed (unmasked) through the single-view encoder to generate feature embeddings. These features are average-pooled across patches to produce a single embedding per detection, which is then split into view-agnostic and view-specific components. For single-camera tracking, the present embodiments can integrate the view-specific features for within-camera association, using Kalman filtering to refine tracks. For cross-camera matching, we use the view-agnostic features to compute the association matrix, without applying any Kalman filtering.

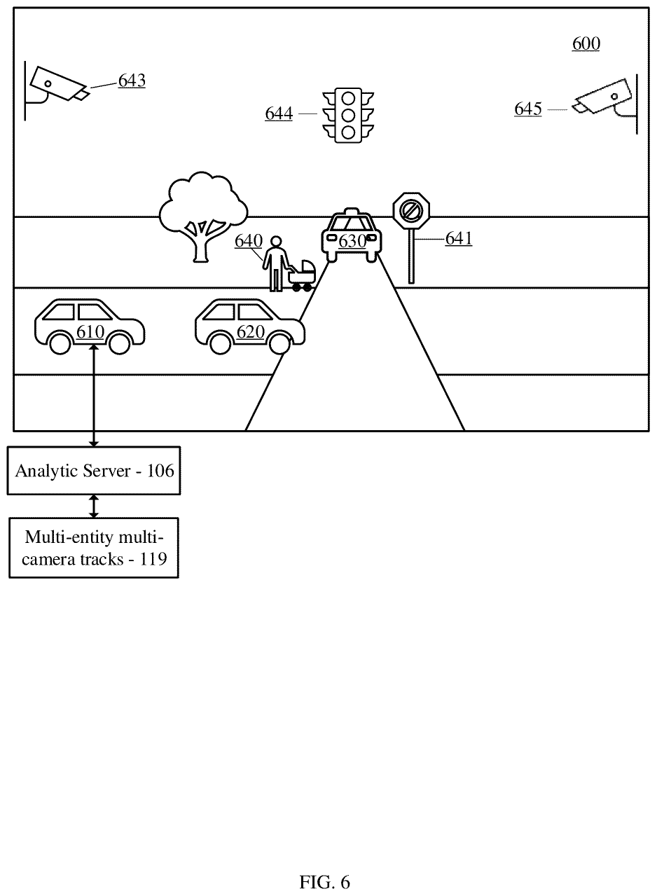

Referring now to FIG. 6, a block diagram showing a practical application of self-supervised feature disentanglement for calibration-free multi-camera multi-object tracking, in accordance with an embodiment of the present invention.

In an embodiment, in traffic scene 600, vehicle 610 can communicate with analytic server 106 through a network. Input videos 102 from camera 643 and 645 can be processed by vehicle 610 through the analytic server 106 through the network. The vehicle 610 can process multi-entity multi-camera track 119 and control the vehicle 610 (e.g., speeding up, braking, change direction, etc.).

Vehicle 610 can autonomously understand the traffic scene 600 and generate trajectories from multi-entity multi-camera track 119 based on the traffic scene. The trajectories can include predictions of trajectories of the entities in the traffic scene 600. For example, the multi-entity multi-camera track 119 can include a track that follows the entities in the traffic scene which can be described as: “vehicle (620) is in the intersection where pedestrian (640) is also crossing the intersection and taxi (630) is stopped behind one-way sign (641) as the light on traffic light (644) is red for taxi (630) and green for vehicle (620).”

In another embodiment, in traffic scene 600, vehicle 610 can simulate trajectories for the identified entities. In another embodiment, in traffic scene 600, based on the simulated trajectories of the identified entities, vehicle 610 can generate a trajectory to avoid the simulated trajectories of the identified entities and avoid collisions. In another embodiment, the vehicle 610 can be autonomously controlled based on the generated trajectory to avoid collisions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
identifying view-specific features and view-agnostic features of a tracked entity from different camera views by encoding masked detection features of the tracked entity;
reconstructing the masked detection features into single-view feature representations from the view-specific features;
generating cross-view feature representations from the view-agnostic features that capture shared characteristics from the different camera views; and
combining the single-view feature representations and the cross-view feature representations into multi-entity multi-camera tracks that capture the characteristics of the tracked entity from the different camera views for downstream tasks.

2. The method of claim 1, wherein identifying the view-specific features further comprises generating entity detections of the tracked entity from the camera views.

3. The method of claim 2, wherein identifying the view-specific features further comprises dividing the entity detections into non-overlapping patches to obtain detection tokens.

4. The method of claim 3, wherein identifying the view-specific features further comprises masking the detection tokens to preserve positional encoding from the entity detections.

5. The method of claim 3, wherein identifying the view-specific features further comprises separating the detection tokens into view-agnostic features and view-specific features with a disentanglement loss.

6. The method of claim 1, wherein reconstructing the masked detection features further comprises obtaining patch-level targets from unmasked entity detections to detect view-specific cues.

7. The method of claim 1, wherein the downstream tasks include controlling an autonomous vehicle based on a trajectory generated from the multi-entity multi-camera tracks.

8. A system, comprising:
a memory device;
one or more processor devices operatively coupled with the memory device to perform operations including:
identifying view-specific features and view-agnostic features of a tracked entity from different camera views by encoding masked detection features of the tracked entity;
reconstructing the masked detection features into single-view feature representations from the view-specific features;
generating cross-view feature representations from the view-agnostic features that capture shared characteristics from the different camera views; and
combining the single-view feature representations and the cross-view feature representations into multi-entity multi-camera tracks that capture the characteristics of the tracked entity from the different camera views for downstream tasks.

9. The system of claim 8, wherein identifying the view-specific features further comprises generating entity detections of the tracked entity from the camera views.

10. The system of claim 9, wherein identifying the view-specific features further comprises dividing the entity detections into non-overlapping patches to obtain detection tokens.

11. The system of claim 10, wherein identifying the view-specific features further comprises masking the detection tokens to preserve positional encoding from the entity detections.

12. The system of claim 10, wherein identifying the view-specific features further comprises separating the detection tokens into view-agnostic features and view-specific features with a disentanglement loss.

13. The system of claim 8, wherein reconstructing the masked detection features further comprises obtaining patch-level targets from unmasked entity detections to detect view-specific cues.

14. The system of claim 8, wherein the downstream tasks include controlling an autonomous vehicle based on a trajectory generated from the multi-entity multi-camera tracks.

15. A non-transitory computer program product comprising a computer-readable storage medium including a program code, wherein the program code when executed on a computer causes the computer to perform operations including:
identifying view-specific features and view-agnostic features of a tracked entity from different camera views by encoding masked detection features of the tracked entity;
reconstructing the masked detection features into single-view feature representations from the view-specific features;
generating cross-view feature representations from the view-agnostic features that capture shared characteristics from the different camera views; and
combining the single-view feature representations and the cross-view feature representations into multi-entity multi-camera tracks that capture the characteristics of the tracked entity from the different camera views for downstream tasks.

16. The non-transitory computer program of claim 15, wherein identifying the view-specific features further comprises generating entity detections of the tracked entity from the camera views.

17. The non-transitory computer program of claim 16, wherein identifying the view-specific features further comprises dividing the entity detections into non-overlapping patches to obtain detection tokens.

18. The non-transitory computer program of claim 17, wherein identifying the view-specific features further comprises masking the detection tokens to preserve positional encoding from the entity detections.

19. The non-transitory computer program of claim 17, wherein identifying the view-specific features further comprises separating the detection tokens into view-agnostic features and view-specific features with a disentanglement loss.

20. The non-transitory computer program of claim 15, wherein the downstream tasks include controlling an autonomous vehicle based on a trajectory generated from the multi-entity multi-camera tracks.
